(19) United States
(12) Patent Application Publication
(10) Pub. No.: US 2008/0269051 A1
(43) Pub. Date: Oct. 30, 2008

(54) Fungicidal Active Compound Combinations

(75) Inventors: Anne Suty-Heinze, Langenfeld (DE); Friedrich Kerz-Mohlendick, Leverkusen (DE); Stefan Dutzmann, Langenfeld (DE); Ulrich Heinemann, Leichlingen (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: BAYER CORPSCIENCE AG, Leverkusen (DE)

(21) Appl. No.: 11/576,756

(22) PCT Filed: Oct. 11, 2005
(86) PCT No.: PCT/EP05/10919

§ 371 Date: Jun. 5, 2008

(30) Foreign Application Priority Data
Oct. 12, 2004 (DE) 10 2004 049 761.3

(51) Int. Cl. A01N 25/34; A01N 43/88; A01P 3/00

(52) U.S. Cl. 504/100; 514/229.2

(57) ABSTRACT

The invention relates to active compound combinations comprising firstly the known fluoxastrobin and secondly further known fungicidal active compounds, which combinations are highly suitable for controlling unwanted phytopathogenic fungi.

The invention relates to active compound combinations comprising firstly the known fluoxastrobin and secondly further known fungicidal active compounds, which combinations are highly suitable for controlling unwanted phytopathogenic fungi.

It is already known that the compound of the formula (I

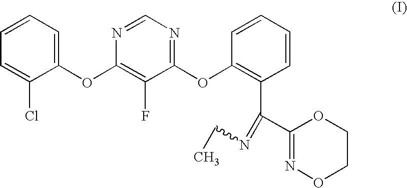

(fluoxastrobin)
has fungicidal properties (WO 97/27189).

Furthermore, it is already known that numerous triazole derivatives, aniline derivatives, dicarboximides and other heterocycles can be employed for controlling fungi (cf. EP-A 0 040 345, DE-A 22 01 063, DE-A 23 24 010, Pesticide Manual, 9th Edition (1991), pages 249 and 827, EP-A 0 382 375 and EP-A 0 515 901). However, at low application rates, the activity of these compounds is also not always sufficient.

Furthermore, it is already known that 1-(3,5-dimethylisoxazol-4-sulphonyl)-2-chloro-6,6-di-fluoro-[1,3]-dioxolo-[4,5f]-benzimidazole has fungicidal properties (cf. WO 97/06171).

Finally, it is also known that substituted halopyrimidines have fungicidal properties (cf. DE-A1-196 46 407, EP-B-712 396).

We have now found novel active compound combinations having very good fungicidal properties, comprising fluoxastrobin (group 1)

and at least one active compound from groups (2) to (15) below:
triazole fungicides of group (2):
(2-1) azaconazole (known from DE-A 25 51 560) of the formula

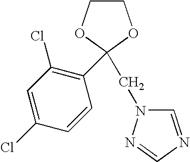

(2-2) etaconazole (known from DE-A 25 51 560) of the formula

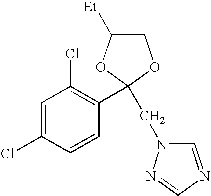

(2-3) difenoconazole (known from EP-A 0 112 284) of the formula

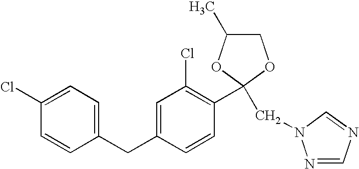

(2-4) bromuconazole (known from EP-A 0 258 161) of the formula

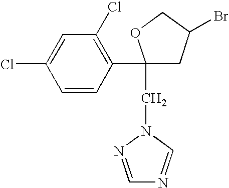

(2-5) cyproconazole (known from DE-A 34 06 993) of the formula

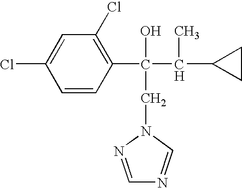

(2-6) hexaconazole (known from DE-A 30 42 303) of the formula

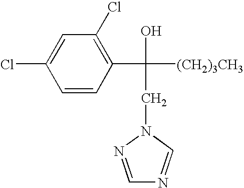

(2-7) penconazole (known from DE-A 27 35 872) of the formula

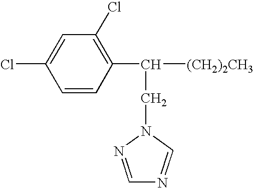

(2-8) myclobutanil (known from EP-A 0 145 294) of the formula

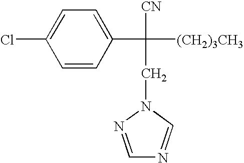

(2-9) tetraconazole (known from EP-A 0 234 242) of the formula

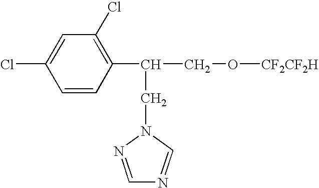

(2-10) flutriafol (known from EP-A 0 015 756) of the formula

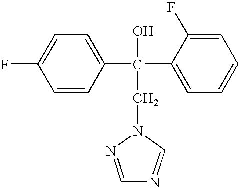

(2-11) flusilazole (known from EP-A 0 068 813) of the formula

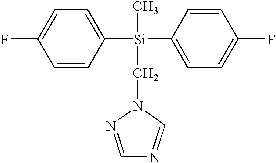

(2-12) simeconazole (known from EP-A 0 537 957) of the formula

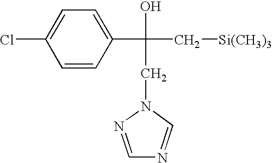

(2-13) fenbuconazole (known from DE-A 37 21 786) of the formula

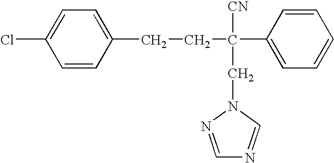

(2-14) ipconazole (known from EP-A 0 329 397) of the formula

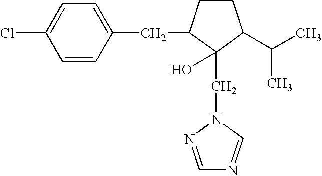

(2-15) triticonazole (known from EP-A 0 378 953) of the formula

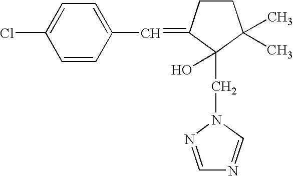

(2-16) quinconazole (known from EP-A 0 183 458) of the formula

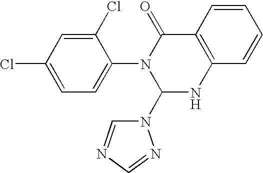

carboxamides of group (3):
(3-1) boscalid (known from DE-A 195 31 813) of the formula

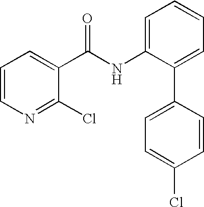

(3-2) furametpyr (known from EP-A 0 315 502) of the formula

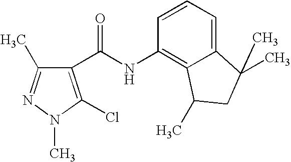

(3-3) picobenzamid (known from WO 99/42447) of the formula

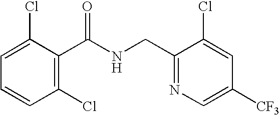

(3-4) zoxamide (known from EP-A 0 604 019) of the formula

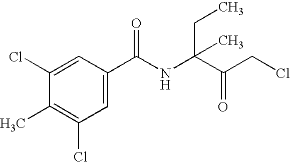

(3-5) carboxin (known from U.S. Pat. No. 3,249,499) of the formula

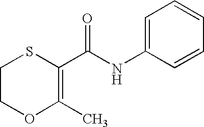

(3-6) tiadinil (known from U.S. Pat. No. 6,616,054) of the formula

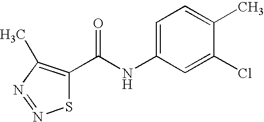

(3-7) penthiopyrad (known from EP-A 0 737 682) of the formula

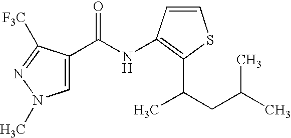

(3-8) silthiofam (known from WO 96/18631) of the formula

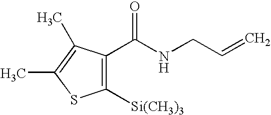

dithiocarbamates of group (4):
(4-1) maneb (known from U.S. Pat. No. 2,504,404) of the formula

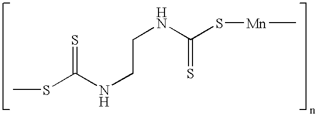

(4-2) metiram (known from DE-A 10 76 434) having the IUPAC name zinc ammoniate ethylenebis(dithiocarbamate)-poly(ethylenethiuram disulphide)
(4-3) thiram (known from U.S. Pat. No. 1,972,961) of the formula

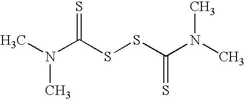

(4-4) zineb (known from DE-A 10 81 446) of the formula

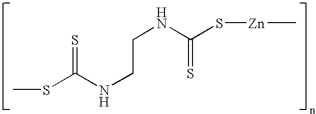

(4-5) ziram (known from U.S. Pat. No. 2,588,428) of the formula

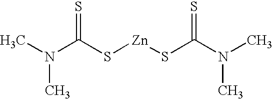

acylalamines of group (5):
(5-1) benalaxyl (known from DE-A 29 03 612) of the formula

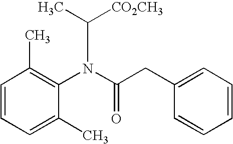

(5-2) furalaxyl (known from DE-A 25 13 732) of the formula

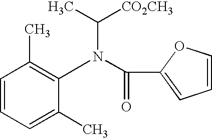

(5-3) metalaxyl-M (known from WO 96/01559) of the formula

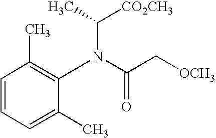

(5-4) benalaxyl-M of the formula

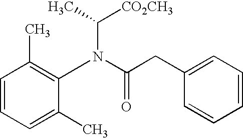

benzimidazoles of group (6):
(6-1) benomyl (known from U.S. Pat. No. 3,631,176) of the formula

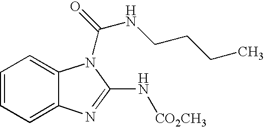

(6-2) carbendazim (known from U.S. Pat. No. 3,010,968) of the formula

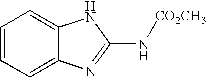

(6-3) chlorfenazole of the formula

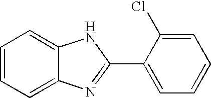

(6-4) fuberidazole (known from DE-A 12 09 799) of the formula

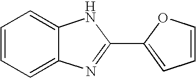

(6-5) thiabendazole (known from U.S. Pat. No. 3,206,468) of the formula

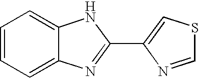

carbamates of group (7):
(7-1) propamocarb (known from U.S. Pat. No. 3,513,241) of the formula

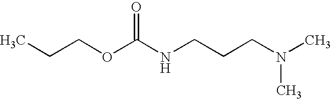

(7-2) propamocarb hydrochloride (known from U.S. Pat. No. 3,513,241) of the formula

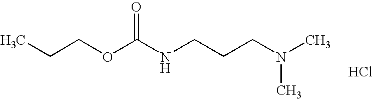

(7-3) propamocarb-fosetyl of the formula

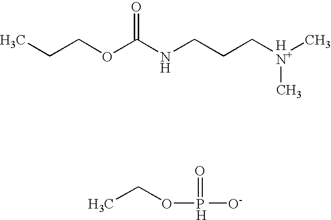

dicarboximides of group (8)
(8-1) captafol (known from U.S. Pat. No. 3,178,447) of the formula

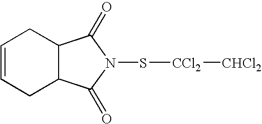

(8-2) procymidone (known from DE-A 20 12 656) of the formula

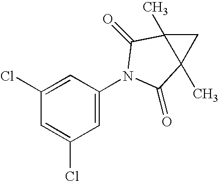

(8-3) vinclozolin (known from DE-A 22 07 576) of the formula

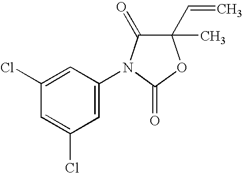

guanidines of group (9):
(9-1) dodine (known from GB 11 03 989) of the formula

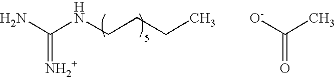

(9-2) guazatine (known from GB 11 14 155)
(9-3) iminoctadine triacetate (known from EP-A 0 155 509) of the formula

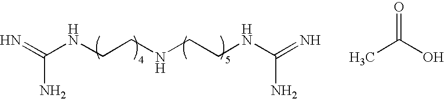

imidazoles of group (10):
(10-1) cyazofamid (known from EP-A 0 298 196) of the formula

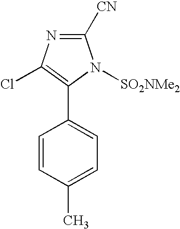

(10-2) prochloraz (known from DE-A 24 29 523) of the formula

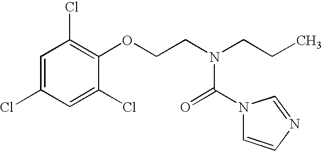

(10-3) triazoxide (known from DE-A 28 02 488) of the formula

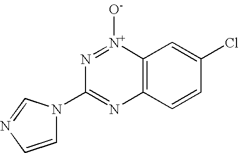

(10-4) pefurazoate (known from EP-A 0 248 086) of the formula

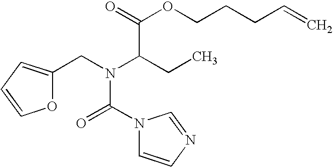

morpholines of group (11):
(11-1) aldimorph (known from DD 140 041) of the formula

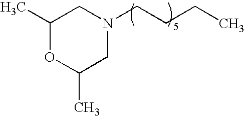

(11-2) tridemorph (known from GB 988 630) of the formula

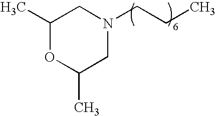

(11-3) dodemorph (known from DE-A 25 432 79) of the formula

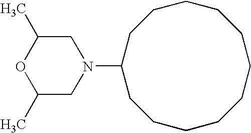

(11-4) fenpropimorph (known from DE-A 26 56 747) of the formula

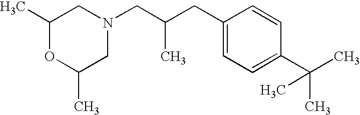

pyrroles of group (12):
(12-1) pyrrolnitrine (known from JP 65-25876) of the formula

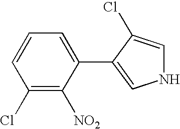

other fungicides (13):
(13-1) edifenphos (known from DE-A 14 93 736) of the formula

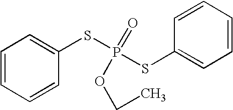

(13-2) copper oxychloride
(13-3) oxadixyl (known from DE-A 30 30 026) of the formula

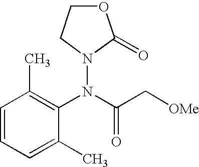

(13-4) dithianon (known from JP-A 44-29464) of the formula

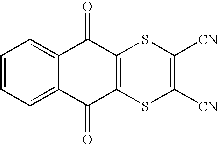

(13-5) metrafenone (known from EP-A 0 897 904) of the formula

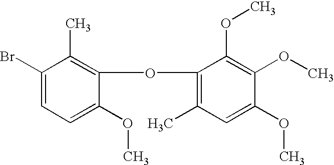

(13-6) fenamidone (known from EP-A 0 629 616) of the formula

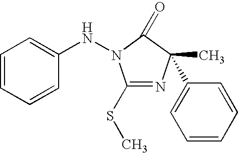

(13-7) 2,3-dibutyl-6-chlorothieno[2,3-d]pyrimidin-4(3H)one (known from WO 99/14202) of the formula

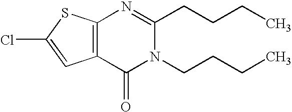

(13-8) probenazole (known from U.S. Pat. No. 3,629,428) of the formula

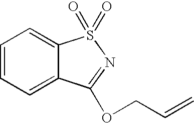

(13-9) isoprothiolane (known from U.S. Pat. No. 3,856,814) of the formula

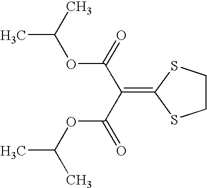

(13-10) kasugamycin (known from GB 1 094 567) of the formula

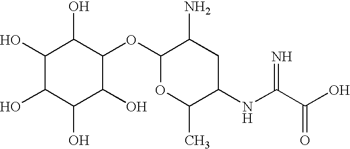

(13-11) phthalide (known from JP-A 57-55844) of the formula

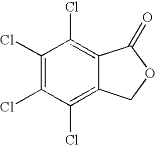

(13-12) ferimzone (known from EP-A 0 019 450) of the formula

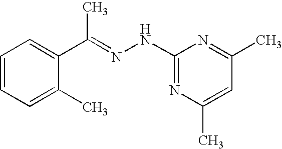

(13-13) tricyclazole (known from DE-A 22 50 077) of the formula

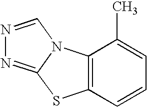

(13-14) N-({4-[(cyclopropylamino)carbonyl]phenyl}sulphonyl)-2-methoxybenzamide of the formula

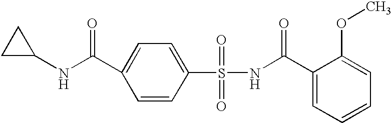

(thio)urea derivatives of group (14):
(14-1) thiophanate-methyl (known from DE-A 18 06 123) of the formula

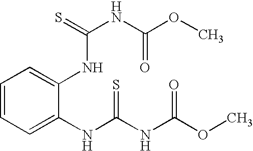

(14-2) thiophanate-ethyl (known from DE-A 18 06 123) of the formula

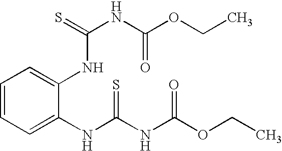

and
amides of group (15):
(15-1) fenoxanil (known from EP-A 0 262 393) of the formula

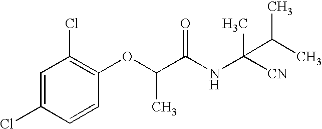

(15-2) dicylcomat (known from JP-A 7-206608) of the formula

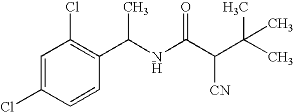

In addition to an active compound of the formula (I), the active compound combinations according to the invention comprise at least one active compound from the compounds of groups (2) to (15). Moreover, they may also comprise further fungicidally active mixing components.

If the active compounds in the active compound combinations according to the invention are present in certain weight ratios, a synergistic effect is particularly pronounced. However, the weight ratios in the active compound combinations may be varied within a relatively large range. In general, the combinations according to the invention comprise active compounds of the formula (I) and a mixing partner of one of groups (2) to (15) in the mixing ratios listed in an exemplary manner in Table 1 below.

The mixing ratios are based on weight ratios. The ratio is to be understood as meaning active compound of the formula (I): mixing partner.

TABLE 1
Mixing ratios

| | | | particularly |
|---|---|---|---|
| | | preferred | preferred |
| Mixing partner | | mixing ratio | mixing ratio |
| Group (2): | triazoles | 50:1 to 1:50 | 20:1 to 1:20 |
| Group (3): | carboxamides | 50:1 to 1:50 | 20:1 to 1:20 |
| Group (4): | dithiocarbamates | 1:1 to 1:150 | 1:1 to 1:100 |
| Group (5): | acylalanines | 10:1 to 1:150 | 5:1 to 1:100 |
| Group (6): | benzimidazoles | 10:1 to 1:50 | 5:1 to 1:20 |
| Group (7): | carbamates | 1:1 to 1:150 | 1:1 to 1:100 |
| Group (8): | dicarboximides | 5:1 to 1:150 | 1:1 to 1:100 |
| Group (9): | guanidines | 100:1 to 1:150 | 20:1 to 1:100 |
| Group (10): | imidazoles | 50:1 to 1:50 | 10:1 to 1:20 |
| Group (11): | morpholines | 50:1 to 1:50 | 10:1 to 1:20 |
| Group (12): | pyrroles | 50:1 to 1:50 | 10:1 to 1:20 |
| (13-1): | edifenphos | 10:1 to 1:50 | 5:1 to 1:20 |
| (13-2): | copper oxychloride | 1:1 to 1:150 | 1:5 to 1:100 |
| (13-3): | oxadixyl | 10:1 to 1:150 | 5:1 to 1:100 |
| (13-4): | dithianon | 50:1 to 1:50 | 10:1 to 1:20 |
| (13-5): | metrafenone | 50:1 to 1:50 | 10:1 to 1:20 |
| (13-6): | fenamidone | 50:1 to 1:50 | 10:1 to 1:20 |
| (13-7): | 2,3-dibutyl-6-chloro- | 50:1 to 1:50 | 10:1 to 1:20 |
| | thieno-[2,3-d]pyrim- | | |
| | idin-4(3H)one | | |
| (13-8): | probenazole | 10:1 to 1:150 | 5:1 to 1:100 |
| (13-9): | isoprothiolane | 10:1 to 1:150 | 5:1 to 1:100 |
| (13-10): | kasugamycin | 50:1 to 1:50 | 10:1 to 1:20 |
| (13-11): | phthalide | 10:1 to 1:150 | 5:1 to 1:100 |
| (13-12): | ferimzone | 50:1 to 1:50 | 10:1 to 1:20 |
| (13-13): | tricyclazole | 50:1 to 1:50 | 10:1 to 1:20 |
| (13-14): | N-({4-[(cyclopropyl- | 10:1 to 1:150 | 5:1 to 1:100 |
| | amino)-carbonyl]phe- | | |
| | nyl}sulphonyl)-2- | | |
| | methoxybenzamide | | |
| (14): | (thio)urea derivatives | 50:1 to 1:50 | 10:1 to 1:20 |
| (15): | amides | 50:1 to 1:50 | 10:1 to 1:20 |

In each case, the mixing ratio is advantageously to be chosen such that a synergistic mixture is obtained. The mixing ratios of the compound of the formula (I) and a compound of one of groups (2) to (15) may also vary between the individual compounds of a group.

In addition, the active compounds according to the invention have very good fungicidal properties and can be used for controlling phytopathogenic fungi, such as Plasmo-diophoromycetes, Oomycetes, Chytridiomycetes, Zygomycetes, Ascomycetes, Basi-diomycetes, Deuteromycetes etc.

Some pathogens causing fungal and bacterial diseases which come under the generic names listed above may be mentioned as examples, but not by way of limitation:

Xanthomonas species, such as, for example, Xanthomonas campestris pv. oryzae;
Pseudomonas species, such as, for example, Pseudomonas syringae pv. lachrymans;
Erwinia species, such as, for example, Erwinia amylovora;

Diseases caused by powdery mildew pathogens, such as, for example,

Blumeria species, such as, for example, Blumeria graminis;
Podosphaera species, such as, for example, Podosphaera leucotricha;
Sphaerotheca species, such as, for example, Sphaerotheca fuliginea;
Uncinula species, such as, for example, Uncinula necator;

Diseases caused by rust disease pathogens, such as, for example,

Gyrnnosporangium species, such as, for example, Gymnosporangium sabinae
Hemileia species, such as, for example, Hemileia vastatrix;
Phakopsora species, such as, for example, Phakopsora pachyrhizi and Phakopsora meibomiae;
Puccinia species, such as, for example, Puccinia recondita;
Uromyces species, such as, for example, Uromyces appendiculatus;

Diseases caused by pathogens from the group of the Oomycetes, such as, for example,

Bremia species, such as, for example, Bremia lactucae;
Peronospora species, such as, for example, Peronospora pisi or P. brassicae;
Phytophthora species, such as, for example Phytophthora infestans;
Plasmopara species, such as, for example, Plasmopara viticola;
Pseudoperonospora species, such as, for example, Pseudoperonospora humuli or Pseudoperonospora cubensis;
Pythium species, such as, for example, Pythium ultimum;

Leaf blotch diseases and leaf wilt diseases caused, for example, by

Alternaria species, such as, for example, Alternaria solani;
Cercospora species, such as, for example, Cercospora beticola;
Cladiosporum species, such as, for example, Cladiosporium cucumerinum;
Cochliobolus species, such as, for example, Cochliobolus sativus
(conidia form: Drechslera, Syn: Helminthosporium);
Colletotrichum species, such as, for example, Colletotrichum lindemuthanium;
Cycloconium species, such as, for example, Cycloconium oleaginum;
Diaporthe species, such as, for example, Diaporthe citri;
Elsinoe species, such as, for example, Elsinoe fawcettii;
Gloeosporium species, such as, for example, Gloeosporium laeticolor;
Glomerella species, such as, for example, Glomerella cingulata;
Guignardia species, such as, for example, Guignardia bidwelli;
Leptosphaeria species, such as, for example, Leptosphaeria maculans;
Magnaporthe species, such as, for example, Magnaporthe grisea;
Mycosphaerella species, such as, for example, Mycosphaerelle graminicola;
Phaeosphaeria species, such as, for example, Phaeosphaeria nodorum;
Pyrenophora species, such as, for example, Pyrenophora teres;
Ramularia species, such as, for example, Ramularia collo-cygni;
Rhynchosporium species, such as, for example, Rhynchosporium secalis;
Septoria species, such as, for example, Septoria apii;
Typhula species, such as, for example, Typhula incamata;
Venturia species, such as, for example, Venturia inaequalis;

Root and stem diseases caused, for example, by

Corticium species, such as, for example, Corticium graminearum;
Fusarium species, such as, for example, Fusarium oxysporum;
Gaeumannomyces species, such as, for example, Gaeumannomyces graminis;
Rhizoctonia species, such as, for example Rhizoctonia solani;
Tapesia species, such as, for example, Tapesia acuformis;
Thielaviopsis species, such as, for example, Thielaviopsis basicola;

Ear and panicle diseases (including maize crops) caused, for example, by

Alternaria species, such as, for example, Alternaria spp.;
Aspergillus species, such as, for example, Aspergillus flavus;
Cladosporium species, such as, for example, Cladosporium spp.;
Claviceps species, such as, for example, Claviceps purpurea;
Fusarium species, such as, for example, Fusarium culmorum;
Gibberella species, such as, for example, Gibberella zeae;
Monographella species, such as, for example, Monographella nivalis;

Diseases caused by smut fungi, such as, for example,

Sphacelotheca species, such as, for example, Sphacelotheca reiliana;
Tilletia species, such as, for example, Tilletia caries;
Urocystis species, such as, for example, Urocystis occulta;
Ustilago species, such as, for example, Ustilago nuda;

Fruit rot caused, for example, by

Aspergillus species, such as, for example, Aspergillus flavus;
Botrytis species, such as, for example, Botrytis cinerea;
Penicillium species, such as, for example, Penicillium expansum;
Sclerotinia species, such as, for example, Sclerotinia sclerotiorum;
Verticilium species, such as, for example, Verticilium alboatrum;

Seed- and soil-borne rot and wilt diseases, and also diseases of seedlings, caused, for example, by

Fusarium species, such as, for example, Fusarium culmorum;
Phytophthora species, such as, for example, Phytophthora cactorum;
Pythium species, such as, for example, Pythium ultimum;
Rhizoctonia species, such as, for example, Rhizoctonia solani;
Sclerotium species, such as, for example, Sclerotium rolfsii;

Cancerous diseases, galls and witches' broom caused, for example, by

Nectria species, such as, for example, Nectria galligena;

Wilt diseases caused, for example, by

Monilinia species, such as, for example, Monilinia laxa;

Deformations of leaves, flowers and fruits caused, for example, by

Taphrina species, such as, for example, Taphrina deformans;

Degenerative diseases of woody plants caused, for example, by

Esca species, such as, for example, Phaemoniella clamydospora;

Diseases of flowers and seeds caused, for example, by

Botrytis species, such as, for example, Botrytis cinerea;

Diseases of plant tubers caused, for example, by

Rhizoctonia species, such as, for example, Rhizoctonia solani.

The fact that the active compound combinations are well tolerated by plants at the concentrations required for controlling plant diseases permits a treatment of entire plants (above-ground parts of plants and roots), of propagation stock and seed, and of the soil. The active compound combinations according to the invention can be used for foliar application or else as seed dressings.

The fact that the combinations which can be used are well tolerated by plants at the concentrations required for controlling plant diseases permits a treatment of the seed. Accordingly, the active compounds according to the invention can be used as seed dressings.

A large part of the damage to crop plants which is caused by phytopathogenic fungi occurs as early as when the seed is attacked during storage and after the seed is introduced into the soil, as well as during and immediately after germination of the plants. This phase is particularly critical since the roots and shoots of the growing plant are particularly sensitive and even minor damage can lead to the death of the whole plant. Protecting the seed and the germinating plant by the use of suitable compositions is therefore of particularly great interest.

The control of phytopathogenic fungi which damage plants post-emergence is carried out primarily by treating the soil and the above-ground parts of plants with crop protection agents. Owing to the concerns regarding a possible impact of crop protection agents on the environment and the health of man and animals, there are efforts to reduce the amount of active compounds applied.

The control of phytopathogenic fungi by treating the seeds of plants has been known for a long time and is subject-matter of continuous improvements. However, the treatment of seed frequently entails a series of problems which cannot always be solved in a satisfactory manner. Thus, it is desirable to develop methods for protecting the seed and the germinating plant which dispense with the additional application of crop protection agents after sowing or after the emergence of the plants or where additional application is at least reduced. It is furthermore desirable to optimize the amount of active compound employed in such a way as to provide maximum protection for the seed and the germinating plant from attack by phytopathogenic fungi, but without damaging the plant itself by the active compound employed. In particular, methods for the treatment of seed should also take into consideration the intrinsic fungicidal properties of transgenic plants in order to achieve optimum protection of the seed and the germinating plant with a minimum of crop protection agents being employed.

The invention therefore in particular also relates to a method for the protection of seed and germinating plants from attack by phytopathogenic fungi, by treating the seed with a composition according to the invention.

The invention likewise relates to the use of the compositions according to the invention for treating seed in order to protect the seed and the germinating plant from phytopathogenic fungi.

Furthermore, the invention relates to seed which has been treated, in particular coated, with a composition according to the invention so as to afford protection from phytopathogenic fungi.

One of the advantages of the present invention is that, owing to the particular systemic properties of the compositions according to the invention, treatment of the seed with these compositions not only protects the seed itself, but also the resulting plants after emergence, from phytopathogenic fungi. In this manner, the immediate treatment of the crop at the time of sowing or shortly thereafter can be dispensed with.

Furthermore, it must be considered as advantageous that the mixtures according to the invention can also be employed in particular in transgenic seed.

The compositions according to the invention are suitable for protecting seed of any plant variety which is employed in agriculture, in the greenhouse, in forests or in horticulture. In particular, this takes the form of seed of cereals (such as wheat, barley, rye, millet and oats), maize, cotton, soya beans, rice, potatoes, sunflowers, beans, coffee, beet (for example sugar beet and fodder beet), peanuts, vegetables (such as tomatoes, cucumbers, onions and lettuce), lawn and ornamental plants. The treatment of seed of cereals (such as wheat, barley, rye and oats), maize and rice is of particular importance.

In the context of the present invention, the composition according to the invention is applied to the seed either alone or in a suitable formulation. Preferably, the seed is treated in a state which is stable enough to avoid damage during treatment. In general, the seed may be treated at any point in time between harvest and sowing. The seed usually used has been separated from the plant and freed from cobs, shells, stalks, coats, hairs or the flesh of the fruits. Thus, for example, it is possible to use seed which has been harvested, cleaned and dried to a moisture content of below 15% by weight. Alternatively, it is also possible to use seed which, after drying, has, for example, been treated with water and then dried again.

When treating the seed, care must generally be taken that the amount of the composition according to the invention applied to the seed and/or the amount of further additives is chosen in such a way that the germination of the seed is not adversely affected, or that the resulting plant is not damaged. This must be borne in mind in particular in the case of active compounds which may have phytotoxic effects at certain application rates.

The compositions according to the invention can be applied directly, that is to say without comprising further components and without having been diluted. In general, it is preferable to apply the composition to the seed in the form of a suitable formulation. Suitable formulations and methods for the treatment of seed are known to the skilled worker and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186 A2.

The active compound combinations according to the invention are also suitable for increasing the yield of crops. In addition, they show reduced toxicity and are well tolerated by plants.

According to the invention, it is possible to treat all plants and parts of plants. Plants are to be understood here as meaning all plants and plant populations, such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested material and vegetative and generative propagation material, for example seedlings, tubers, rhizomes, cuttings and seeds.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multilayer coating.

As already mentioned above, it is possible to treat all plants and their parts according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof, are treated. The term “parts” or “parts of plants” or “plant parts” has been explained above.

Particularly preferably, plants of the plant cultivars which are in each case commercially available or in use are treated according to the invention.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidal active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are emphasized are in particular increased defense of the plants against insects, by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned also include the varieties sold under the name Clearfield® (for example maize). Of course, these statements also apply to plant cultivars which have these genetic traits or genetic traits still to be developed, and which will be developed and/or marketed in the future.

Depending on their particular physical and/or chemical properties, the active compound combinations according to the invention can be converted into the customary formulations, such as solutions, emulsions, suspensions, powders, dusts, foams, pastes, soluble powders, granules, aerosols, suspoemulsion concentrates, natural and synthetic materials impregnated with active compound and microencapsulations in polymeric substances and in coating compositions for seeds, and ULV cool and warm fogging formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers.

If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Liquefied gaseous extenders or carriers are to be understood as meaning liquids which are gaseous at standard temperature and under atmospheric pressure, for example aerosol propellants such as butane, propane, nitrogen and carbon dioxide.

Suitable solid carriers are: for example ammonium salts and ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, aryl-sulphonates, or else protein hydrolysates. Suitable dispersants are: for example lignosulphite waste liquors and methylcellulose.

Tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The active compound content of the use forms prepared from the commercial formulations may be varied within wide ranges. The concentration of active compound of the use forms for controlling animal pests, such as insects and acarids, may be from 0.0000001 to 95% by weight of active compound and is preferably from 0.0001 to 1% by weight. Application is in a manner adapted to the use forms.

The formulations for controlling unwanted phytopathogenic fingi generally comprise between 0.1 and 95 percent by weight of active compounds, preferably between 0.5 and 90%.

The active compound combinations according to the invention can be used as such, in the form of their formulations or as the use forms prepared therefrom, such as ready-to-use solutions, emulsifiable concentrates, emulsions, suspensions, wettable powders, soluble powders, dusts and granules. They are used in a customary manner, for example by watering (drenching), drip irrigation, spraying, atomizing, broadcasting, dusting, foaming, spreading-on, and as a powder for dry seed treatment, a solution for seed treatment, a water-soluble powder for seed treatment, a water-soluble powder for slurry treatment, or by encrusting etc.

The active compound combinations according to the invention can, in commercial formulations and in the use forms prepared from these formulations, be present as a mixture with other active compounds, such as insecticides, attractants, sterilants, bactericides, acaricides, nematicides, fungicides, growth regulators, herbicides or safeners.

When using the active compound combinations according to the invention, the application rates can be varied within a relatively wide range, depending on the kind of application. In the treatment of parts of plants, the application rates of active compound combination are generally between 0.1 and 10 000 g/ha, preferably between 10 and 1000 g/ha. In the treatment of seed, the application rates of active compound combination are generally between 0.001 and 50 g per kilogram of seed, preferably between 0.01 and 10 g per kilogram of seed. In the treatment of the soil, the application rates of active compound combination are generally between 0.1 and 10 000 g/ha, preferably between 1 and 5000 g/ha.

The compound (I) and at least one compound of groups 2 to 15 can be applied simultaneously, that is jointly or separately, or in succession, the sequence in the case of separate application generally not having any effect on the control results.

The active compound combinations can be used as such, in the form of concentrates or in the form of generally customary formulations, such as powders, granules, solutions, suspensions, emulsions or pastes.

The formulations mentioned can be prepared in a manner known per se, for example by mixing the active compounds with at least one solvent or diluent, emulsifier, dispersant and/or binder or fixative, water repellent, if desired desiccants and UV stabilizers, and, if desired, colorants and pigments and other processing auxiliaries.

The good fungicidal action of the active compound combinations according to the invention is demonstrated by the examples below. While the individual active compounds show weaknesses in their fungicidal action, the combinations show an action which exceeds a simple sum of actions.

A synergistic effect in fungicides is always present when the fungicidal action of the active compound combinations exceeds the total of the action of the active compounds when applied individually.

The expected fungicidal action for a given combination of two active compounds can be calculated as follows, according to S. R. Colby (“Calculating Synergistic and Antagonistic Responses of Herbicide Combinations”, Weeds 1967, 15, 20-22):

If
X is the efficacy when employing active compound A at an application rate of m g/ha,
Y is the efficacy when employing active compound B at an application rate of n g/ha and
E is the efficacy when employing active compounds A and B at application rates of m and n g/ha,
   then

$$E = X + Y - \frac{X \times Y}{100}$$

Here, the efficacy is determined in %. 0% means an efficacy which corresponds to that of the control, whereas an efficacy of 100% means that no infection is observed.

If the actual fungicidal action exceeds the calculated value, the action of the combination is superadditive, i.e. a synergistic effect is present. In this case, the actually observed efficacy must exceed the value calculated using the above formula for the expected efficacy (E).

The invention is illustrated by the examples below. However, the invention is not limited to the examples.

### EXAMPLES

### Example 1

### Pyricularia oryzae Test (In Vitro)/Microtiter Plates

The microtest is carried out in microtiter plates using potato dextrose broth (PDB) as liquid test medium. The active compounds are applied as technical-grade a.i., dissolved in acetone in the case of fluoxastrobin and as a commercially available formulation in the case of silthiofam. For inoculation, a spore suspension of Pyricularia oryzae is used. After 3 days of incubation in the dark and with shaking (10 Hrz) the light transmittance in each filled cavity of the microtiter plates is determined using a spectrophotometer.

0% means an efficacy which corresponds to the growth in the controls, whereas an efficacy of 100% means that no fungal growth is observed.

The table below shows clearly that the activity found for the active compound combination according to the invention is greater than the calculated activity, i.e. that a synergistic effect is present.

TABLE
Pyricularia oryzae test (in vitro)/microtest

| Active compound | Active compound application | |
|---|---|---|
| Known: | rate in ppm | % efficacy |
| fluoxastrobin | 0.1 | 80 |
| silthiofam | 0.1 | 1 |

Mixture according to the invention:

| | | | Active compound | | | Predicted value |
|---|---|---|---|---|---|---|
| | | Mixing | application | | Actual | calculated using |
| | | ratio | rate in ppm | | efficacy | Colby's formula |
| fluoxastrobin + | | | | | | |
| | {close oversize brace} | 1:1 | 0.1 + 0.1 | {close oversize brace} | 99 | 81 |
| silthiofam | | | | | | |

### Example 2

### Rhizoctonia solani Test (In Vitro)/Microtiter Plates

The microtest is carried out in microtiter plates using potato dextrose broth (PDB) as liquid test medium. The active compounds are applied as technical-grade a.i., dissolved in acetone in the case of fluoxastrobin and as a commercially available formulation in the case of boscalid. For inoculation, a mycelium suspension of Rhizoctonia solani is used. After 4 days of incubation in the dark and with shaking (10 Hrz) the light transmittance in each filled cavity of the microtiter plates is determined using a spectrophotometer.

0% means an efficacy which corresponds to the growth in the controls, whereas an efficacy of 100% means that no fungal growth is observed.

The table below shows clearly that the activity found for the active compound combination according to the invention is greater than the calculated activity, i.e. that a synergistic effect is present.

TABLE
Rhizoctonia solani test (in vitro)/microtest

| Active compound | Active compound application | |
|---|---|---|
| Known: | rate in ppm | % efficacy |
| fluoxastrobin | 0.1 | 64 |
| boscalid | 0.1 | 67 |

Mixture according to the invention:

| | | | Active compound | | | Predicted value |
|---|---|---|---|---|---|---|
| | | Mixing | application | | Actual | calculated using |
| | | ratio | rate in ppm | | efficacy | Colby's formula |
| fluoxastrobin + | | | | | | |
| | {close oversize brace} | 1:1 | 0.1 + 0.1 | {close oversize brace} | 95 | 88 |
| boscalid | | | | | | |

### Example 3

### Coriolus versicolor Test (In Vitro)/Microtiter Plates

The microtest is carried out in microtiter plates using potato dextrose broth (PDB) as liquid test medium. The active compounds are applied as technical-grade a.i., dissolved in acetone. For inoculation, a mycelium suspension of Coriolus versicolor is used. After 3 days of incubation in the dark and with shaking (10 Hrz) the light transmittance in each filled cavity of the microtiter plates is determined using a spectrophotometer.

0% means an efficacy which corresponds to the growth in the controls, whereas an efficacy of 100% means that no fungal growth is observed.

The table below shows clearly that the activity found for the active compound combination according to the invention is greater than the calculated activity, i.e. that a synergistic effect is present.

TABLE
Coriolus versicolor test (in vitro)/microtest

| Active compound | Active compound application | |
|---|---|---|
| Known: | rate in ppm | % efficacy |
| fluoxastrobin | 0.03 | 24 |
| difenoconazole | 0.03 | 93 |

Mixture according to the invention:

| | | | Active compound | | | Predicted value |
|---|---|---|---|---|---|---|
| | | Mixing | application | | Actual | calculated using |
| | | ratio | rate in ppm | | efficacy | Colby's formula |
| fluoxastrobin + | | | | | | |
| | {close oversize brace} | 1:1 | 0.03 + 0.03 | {close oversize brace} | 99 | 95 |
| difenoconazole | | | | | | |

### Example 4

### Pyricularia oryzae Test (In Vitro)/Microtiter Plates

The microtest is carried out in microtiter plates using potato dextrose broth (PDB) as liquid test medium. The active compounds are applied as technical-grade a.i., dissolved in acetone. For inoculation, a spore suspension of Pyricularia oryzae is used. After 5 days of incubation in the dark and with shaking (10 Hrz) the light transmittance in each filled cavity of the microtiter plates is determined using a spectrophotometer.

0% means an efficacy which corresponds to the growth in the controls, whereas an efficacy of 100% means that no fungal growth is observed.

The table below shows clearly that the activity found for the active compound combination according to the invention is greater than the calculated activity, i.e. that a synergistic effect is present.

TABLE
Pyricularia oryzae test (in vitro)/microtest

| Active compound | Active compound application | |
|---|---|---|
| Known: | rate in ppm | % efficacy |
| fluoxastrobin | 0.3 | 86 |
| flutriafol | 0.3 | 6 |

Mixture according to the invention:

| | | | Active compound | | | Predicted value |
|---|---|---|---|---|---|---|
| | | Mixing | application | | Actual | calculated using |
| | | ratio | rate in ppm | | efficacy | Colby's formula |
| fluoxastrobin + | | | | | | |
| | {close oversize brace} | 1:1 | 0.3 + 0.3 | {close oversize brace} | 91 | 87 |
| flutriafol | | | | | | |

### Example 5

### Botrytis cinerea Test (In Vitro)/Microtiter Plates

The microtest is carried out in microtiter plates using potato dextrose broth (PDB) as liquid test medium. The active compounds are applied as technical-grade a.i., dissolved in acetone in the case of fluoxastrobin and as a commercially available formulation in the case of ipconazole. For inoculation, a spore suspension of Botrytis cinerea is used. After 3 days of incubation in the dark and with shaking (10 Hrz) the light transmittance in each filled cavity of the microtiter plates is determined using a spectrophotometer.

0% means an efficacy which corresponds to the growth in the controls, whereas an efficacy of 100% means that no fungal growth is observed.

The table below shows clearly that the activity found for the active compound combination according to the invention is greater than the calculated activity, i.e. that a synergistic effect is present.

TABLE
Botrytis cinerea test (in vitro)/microtest

| Active compound | Active compound application | |
|---|---|---|
| Known: | rate in ppm | % efficacy |
| fluoxastrobin | 0.003 | 9 |
| ipconazole | 0.003 | 3 |

Mixture according to the invention:

| | | | Active compound | | | Predicted value |
|---|---|---|---|---|---|---|
| | | Mixing | application | | Actual | calculated using |
| | | ratio | rate in ppm | | efficacy | Colby's formula |
| fluoxastrobin + | | | | | | |
| | {close oversize brace} | 1:1 | 0.003 + 0.003 | {close oversize brace} | 17 | 12 |
| ipconazole | | | | | | |

### Example 6

### Pyricularia oryzae Test (In Vitro)/Microtiter Plates

The microtest is carried out in microtiter plates using potato dextrose broth (PDB) as liquid test medium. The active compounds are applied as technical-grade a.i., dissolved in acetone. For inoculation, a spore suspension of Pyricularia oryzae is used. After 4 days of incubation in the dark and with shaking (10 Hrz) the light transmittance in each filled cavity of the microtiter plates is determined using a spectrophotometer.

0% means an efficacy which corresponds to the growth in the controls, whereas an efficacy of 100% means that no fungal growth is observed.

The table below shows clearly that the activity found for the active compound combination according to the invention is greater than the calculated activity, i.e. that a synergistic effect is present.

TABLE
Pyricularia oryzae test (in vitro)/microtest

| Active compound | Active compound application | |
|---|---|---|
| Known: | rate in ppm | % efficacy |
| fluoxastrobin | 0.1 | 82 |
| myclobutanil | 0.1 | 4 |

Mixture according to the invention:

| | | | Active compound | | | Predicted value |
|---|---|---|---|---|---|---|
| | | Mixing | application | | Actual | calculated using |
| | | ratio | rate in ppm | | efficacy | Colby's formula |
| fluoxastrobin + | | | | | | |
| | {close oversize brace} | 1:1 | 0.1 + 0.1 | {close oversize brace} | 93 | 82 |
| myclobutanil | | | | | | |

### Example 7

### Pyricularia oryzae test (In Vitro)/Microtiter Plates

The microtest is carried out in microtiter plates using potato dextrose broth (PDB) as liquid test medium. The active compounds are applied as technical-grade a.i., dissolved in acetone in the case of fluoxastrobin and as a commercially available formulation in the case of mefenoxam (metalaxyl-M). For inoculation, a spore suspension of Pyricularia oryzae is used. After 3 days of incubation in the dark and with shaking (10 Hrz) the light transmittance in each filled cavity of the microtiter plates is determined using a spectrophotometer.

0% means an efficacy which corresponds to the growth in the controls, whereas an efficacy of 100% means that no fungal growth is observed.

The table below shows clearly that the activity found for the active compound combination according to the invention is greater than the calculated activity, i.e. that a synergistic effect is present.

TABLE
Pyricularia oryzae test (in vitro)/microtest

| Active compound | Active compound application | |
|---|---|---|
| Known: | rate in ppm | % efficacy |
| fluoxastrobin | 0.3 | 84 |
| mefenoxam | 0.3 | 16 |

Mixture according to the invention:

| | | | Active compound | | | Predicted value |
|---|---|---|---|---|---|---|
| | | Mixing | application | | Actual | calculated using |
| | | ratio | rate in ppm | | efficacy | Colby's formula |
| fluoxastrobin + | | | | | | |
| | {close oversize brace} | 1:1 | 0.3 + 0.3 | {close oversize brace} | 99 | 87 |
| mefenoxam | | | | | | |

1. A composition comprising fluoxastrobin and at least one active compound selected from the group consisting of triazole fungicides, carboxamides, dithiocarbamates, acylalamines, benzimidazoles, carbamates, dicarboximides, guanidines, imidazoles, morpholines, pyrroles, other fungicides, (thio)urea derivatives, amides and a mixture thereof,
wherein the triazole fungicides are selected from a group consisting of
(2-1) azaconazole;
(2-2) etaconazole;
(2-3) difenoconazole;
(2-4) bromuconazole;
(2-5) cyproconazole;
(2-6) hexaconazole;
(2-7) penconazole;
(2-8) myclobutanil
(2-9) tetraconazole
(2-10) flutriafol;
(2-11) flusilazole;
(2-12) simeconazole;
(2-13) fenbuconazole;
(2-14) ipconazole;
(2-15) triticonazole; and
(2-16) quinconazole,
the carboxamides are selected from a group consisting of
(3-1) boscalid;
(3-2) furametpyr;
(3-3) picobenzamid;
(3-4) zoxamide;
(3-5) carboxin;
(3-6) tiadinil;
(3-7) penthiopyrad and
(3-8) silthiofam,
the dithiocarbamates are selected from a group consisting of
(4-1) maneb;
(4-2) metiram;
(4-3) thiram;
(4-4) zineb; and
(4-5) ziram,
the acylalamines are selected from a group consisting of
(5-1) benalaxyl;
(5-2) furalaxyl;
(5-3) metalaxyl-M; and
(5-4) benalaxyl-M,
the benzimidazoles are selected from a group consisting of
(6-1) benomyl;
(6-2) carbendazim;
(6-3) chlorfenazole;
(6-4) fuberidazole; and
(6-5) thiabendazole,
the carbamates are selected from a group consisting of
(7-1) propamocarb;
(7-2) propamocarb hydrochloride; and
(7-3) propamocarb-fosetyl,
the dicarboximides are selected from a group consisting of:
(8-1) captafol;
(8-2) procymidone; and
(8-3) vinclozolin,
the guanidines are selected from a group consisting of
(9-1) dodine;
(9-2) guazatine; and
(9-3) iminoctadine triacetate,
the imidazoles are selected from a group consisting of
(10-1) cyazofamid;
(10-2) prochloraz;
(10-3) triazoxide; and
(10-4) pefurazoate,
the morpholines are selected from a group consisting of
(11-1) aldimorph;
(11-2) tridemorph;
(11-3) dodemorph; and
(11-4) fenpropimorph,
the pyrrole is
(12-1) pyrrolnitrine,
the other fungicides are selected from a group consisting of
(13-1) edifenphos;
(13-2) copper oxychloride;
(13-3) oxadixyl;
(13-4) dithianon;
(13-5) metrafenone;
(13-6) fenamidone;
(13-7) 2,3-dibutyl-6-chlorothieno[2,3-d]pyrimidin-4(3H)one;
(13-8) probenazole;
(13-9) isoprothiolane;
(13-10) kasugamycin;
(13-11) phthalide;
(13-12) ferimzone;
(13-13) tricyclazole; and
(13-14) N-({4-[(cyclopropylamino)carbonyl]phenyl}sulphonyl)-2-methoxybenzamide,
the (thio)urea derivatives are selected from a group consisting of:
(14-1) thiophanate-methyl; and
(14-2) thiophanate-ethyl, and
the amides are selected from a group consisting of
(15-1) fenoxanil; and
(15-2) dicylcomat.

2. A method for controlling unwanted phytopathogenic fungi, comprising contacting unwanted phytopathogenic fungi with a composition according to claim 1.

3. A method for treating seed comprising contacting seed with a composition according to claim 1.

4. A method for treating transgenic plants comprising contacting transgenic plants with a composition according to claim 1.

5. A method for treating seed of transgenic plants comprising contacting seed of transgenic plants with a composition according to claim 1.

6. Seed which has been contacted with a composition according to claim 1.

7. A method for controlling unwanted phytopathogenic fungi, comprising contacting a composition according to claim 1 with the unwanted phytopathogenic fungi, their habitat, their seed, or a combination thereof.

8. A process for preparing fungicidal compositions, comprising mixing a composition according to claim 1 with extenders, surfactants or a combination thereof.
